(19) United States
(12) Patent Application Publication
(10) Pub. No.: US 2016/0284004 A1
(43) Pub. Date: Sep. 29, 2016

(54) Methods, Systems, Computer Program Products and Apparatuses for Beverage Recommendations

(71) Applicant: NEXT GLASS, INC., Wilmington, NC (US)

(72) Inventor: Kurt Bagby Taylor, Wilmington, NC (US)

(73) Assignee: NEXT GLASS, INC., Wilmington, NC (US)

(21) Appl. No.: 14/778,301

(22) PCT Filed: Mar. 20, 2014
(86) PCT No.: PCT/US2014/031303

§ 371 Date: Sep. 18, 2015

Related U.S. Application Data
(60) Provisional application No. 61/804,001, filed on Mar. 21, 2013.

(51) Int. Cl. G06Q 30/06; H04L 29/08; G06N 5/04

(52) U.S. Cl. CPC G06Q 30/0631; G06N 5/048; H04L 67/306; H04L 67/18

(57) ABSTRACT

Methods, systems, apparatuses and computer program products for generating a beverage recommendation based on a probable degree of user satisfaction are provided. A user profile for a user is received. A beverage characteristic profile database is queried. The database includes a plurality of beverage selections, and each of the plurality of beverage selections has characteristic profile associated therewith. One or more beverage recommendations are generated in response to the user profile and the beverage characteristic profile of the beverage selections from the beverage characteristic profile database.

### RELATED APPLICATIONS

This application claims priority to U.S. Provisional Application Ser. No. 61/804,001, filed Mar. 21, 2013, the disclosure of which is hereby incorporated by reference in its entirety.

### FIELD OF THE INVENTION

The present invention relates to methods, systems, apparatuses and computer program products for recommending beverages, such as wine, beer, or liquor to a user.

### BACKGROUND

Wine is enjoyed regularly by an estimated 81 million people in the United States alone. Even relatively sophisticated consumers, including restaurants and wine merchants, have difficulty identifying wines that are likely to be successful with a given consumer or a given consumer market. Existing wine recommendation magazines and/or rating systems are generally highly subjective and based on reviews and terms that do little to clarify the actual taste of a wine.

Consumers may struggle to select wines in a market with a large number of available wines with which they are unfamiliar. Wine selection for restaurants and merchants is also challenging without effective tools to guide the selection process. Moreover, wine preferences vary greatly from consumer to consumer, and communicating wine recommendations may be difficult in such a highly individualized area.

### SUMMARY OF EMBODIMENTS OF THE INVENTION

In some embodiments, methods, systems, apparatuses and computer program products for generating a beverage recommendation based on a probable degree of user satisfaction are provided. A user profile for a user is received. A beverage characteristic profile database is queried. The database includes a plurality of beverage selections, and each of the plurality of beverage selections has characteristic profile associated therewith. One or more beverage recommendations are generated in response to the user profile and the beverage characteristic profile of the beverage selections from the beverage characteristic profile database.

In some embodiments, generating one or more beverage recommendations comprises receiving a user input of an identified beverage selection, determining a probable degree of user satisfaction of the identified beverage selection, and providing the probable degree of user satisfaction to the user.

In some embodiments, generating one or more beverage recommendations comprises identifying one or more beverage recommendations in response to the user profile and the beverage characteristic profile of the beverage selections from the beverage characteristic profile database.

In some embodiments, the beverage characteristic profiles of the beverage characteristic profile database include chemical analysis data. The chemical analysis data may include data including data from nuclear magnetic resonance spectroscopy, chromatography (liquid chromatography, gas chromatography, ion chromatography), gel electrophoresis, capillary electrophoresis, mass spectroscopy, spectrophotometry, gravimetry, infra-red spectroscopy, UV-VIS spectrometry, potentiometry tubidimetry data, liquid chromatography coupled with mass spectrometry (LC/MS), gas chromatography coupled with mass spectroscopy (GC/MS), and/or mass spectroscopy coupled with mass spectroscopy (MS/MS). The chemical analysis data may include at least one compound and a molecular weight and/or mass-to-charge ratio and a corresponding quantity. The chemical analysis data may include the chemical analysis data from a liquid sample of the beverage. The chemical analysis data may include the chemical analysis data from a gas sample of gas emitted from the beverage. The chemical analysis data may include a characteristic of at least one compound that does not identify the at least one compound. The chemical analysis data may include an identification of at least one compound.

In some embodiments, the beverage characteristic profiles of the beverage characteristic profile database comprise a container shape, a container type, a stopper type and/or a label image. Generating a beverage recommendation may include digitally or manually analyzing the label image.

In some embodiments, the chemical analysis data includes alcohol content, glucose and/or PH data.

In some embodiments, a location of the user is determined, and the step of generating one or more beverage recommendations is in response to the location of the user, and the one or more beverage recommendations include beverage selections available at the location of the user.

In some embodiments, the user profile is created by receiving one or more user ratings for a corresponding plurality of beverage selections for the user. A composite user profile may be identified in response to the user ratings and utilizing machine learning software methods selected from the group consisting of collaborative filtering, clustering and/or classification.

In some embodiments, the user profile further comprises psychographic data and/or demographic data.

In some embodiments, the beverage is wine, beer and/or liquor.

In some embodiments, generating a beverage recommendation in response to the user profile and the beverage characteristic profile of the beverage selections from the beverage characteristic profile database includes applying machine learning to the user profile, wherein the machine learning is selected from the group consisting of collaborative filtering, clustering and/or classification. The machine learning may include machine-learning collaborative filtering methods including user and item based collaborative filtering (CF), neighbor based CF, Bayesian belief nets CF, clustering CF, MDP based CF, latent semantic CF, sparse factor analysis, dimensionality reduction CF-SVP PCA, content-boosted CF, personality Diagnosis CF, and/or FAB content-based CF. The machine learning may include machine-learning clustering methods including K-means, fuzzy K-means, mean shift, Dirichlet distribution, latent Direchlet allocation, and/or parallel data mining.

In some embodiments, the machine learning comprises machine-learning classification methods including Naïve Bayes, Random Forest Decision tree, support vector machine, k-nearest neighbor, Gaussian mixture models, linear discriminant analysis, and/or logistic regression.

In some embodiments, the machine learning comprises a machine learning cluster analyzer, a machine learning classifier and/or a machine learning collaborative filter that outputs a beverage rating probability for a user associated with the user profile. The beverage rating probability may include a probable rating for a particular beverage selection and/or a beverage recommendation.

In some embodiments, the user profile comprises a group profile including a composite profile responsive to two or more user profiles, and the beverage recommendation is based on a probable degree of user satisfaction for two or more users associated with the two or more user profiles.

In some embodiments, a system for generating a beverage recommendation includes a user interface device configured to receive data for a user profile for a user; and a beverage recommendation module in communication with the user interface device configured to query a beverage characteristic profile database, the database comprising a plurality of beverage selections, each of the plurality of beverage selections having a characteristic profile associated therewith; and to generate one or more beverage recommendations in response to the user profile and the beverage characteristic profile of the beverage selections from the beverage characteristic profile database.

In some embodiments, a computer program product for generating a beverage recommendation is provided. The computer program product includes a computer readable medium having computer readable program code embodied therein, and the computer readable program code includes: computer readable program code configured to receive a user profile for a user; and computer readable program code configured to query a beverage characteristic profile database. The database includes a plurality of beverage selections, and each of the plurality of beverage selections has a characteristic profile associated therewith. The computer program product further includes computer readable program code configured to generate one or more beverage recommendations in response to the user profile and the beverage characteristic profile of the beverage selections from the beverage characteristic profile database.

In some embodiments, a user interface apparatus for generating a beverage recommendation is provided. The user interface apparatus comprises a user interface module configured to receive a user profile for a user; and a processor configured to communicate the user profile to a beverage recommendation module. The beverage recommendation module is configured to query a beverage characteristic profile database, and the database comprises a plurality of beverage selections. Each of the plurality of beverage selections has a characteristic profile associated therewith. The beverage recommendation module is further configured to generate one or more beverage recommendations in response to the user profile and the beverage characteristic profile of the beverage selections from the beverage characteristic profile database and to communicate the one or more beverage selections to the processor.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of a network system according to some embodiments of the present invention.

FIG. 2 is a block diagram of a data processing system according to some embodiments of the present invention.

FIG. 3 is a flowchart of operations according to some embodiments of the present invention.

FIG. 4 is a schematic diagram of operations of a recommendation module according to some embodiments of the present invention.

FIG. 5 is an exemplary graph of chemical data for a beverage selection according to some embodiments of the present invention.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable non-transient storage medium having computer-usable or computer-readable program code embodied in the medium for use by or in connection with an instruction execution system.

The computer-usable or computer-readable medium may be, for example but not limited to, an electronic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

In some embodiments, methods, systems, computer program products and apparatuses for generating a beverage recommendation, such as a wine, beer or liquor recommendation, are provided.

A user profile, including beverage ratings and/or psychographic data, and a beverage characteristic profile database may be provided. The beverage characteristic profile database may include beverage selections having a characteristic profile associated therewith. The beverage characteristic profile may include chemical data for the beverages, including liquid and “headspace” or gas analysis, heritage, price, grape varieties, label information, and the like. The user profile may include user preference data, psychographic behavioral data, demographic data, and the like. One or more beverage recommendations may be identified in response to the user profile and the beverage characteristic profile of the beverage selections from the beverage characteristic profile database.

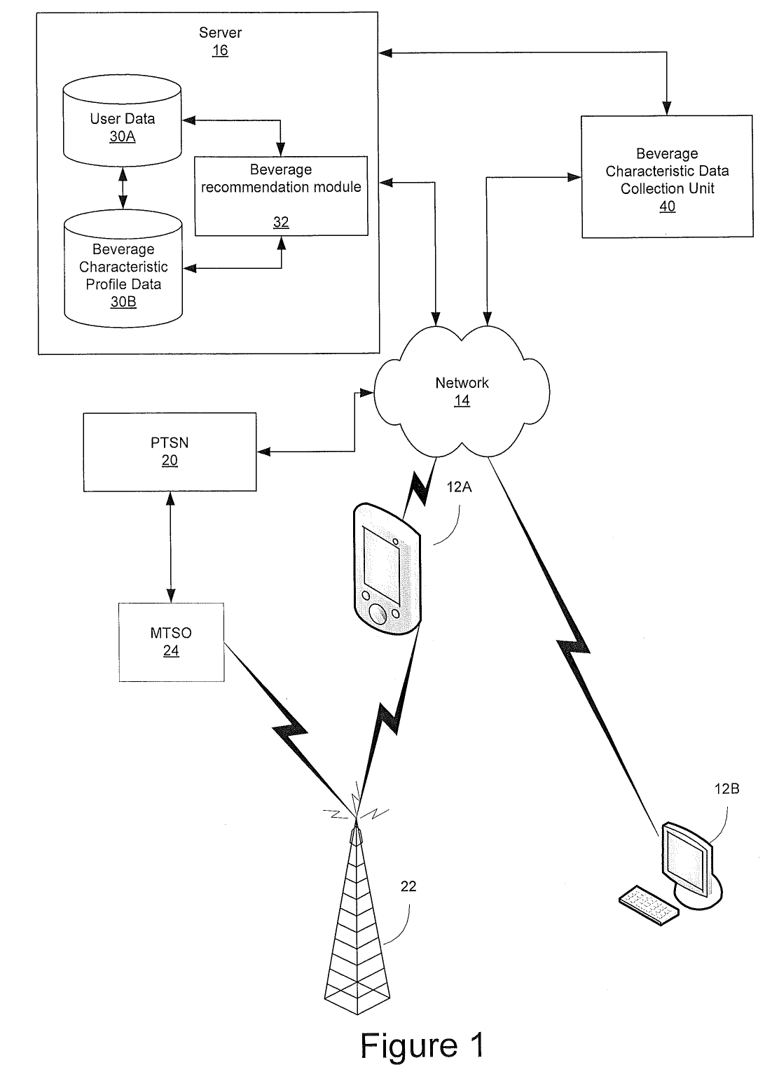

FIG. 1 illustrates a network environment in which embodiments of the present invention may be utilized. As will be appreciated by those of skill in the art, however, the operations of embodiments of the present invention may be carried out on a processing system that communicates with one or more other devices with or without access to a network, such as an intranet or the Internet. As seen in FIG. 1, devices 12A and 12B can communicate over a network 14. The devices 12A and 12B can be any suitable computer device, including, but not limited to, radiotelephones or other handheld devices, such as a personal wirelessly enabled digital assistants (personal data assistants (PDAs), such as Palm Pilot™ or a Pocket PC™, smartphones, pagers, wireless messaging devices (such as a Blackberry™ wireless handheld device), laptop computers, desktop computers, other mobile communications devices and/or combinations thereof. The devices 12A and 12B can communicate through one or more mobile telecommunications switching offices (MTSOs) 24 via base stations 22 and/or may communicate with the network 14 directly. The MTSO 24 may provide communications with a public telecommunications switching network (PTSN) 20, which can, in turn, provide communications with the network 14 or the devices 12A, 12B may be directly or indirectly connected to the network 14 by wireless or wired connections. The devices 12A and 12B may be connected to the network 14 using various techniques, including those known to those of skill in the art.

As is further illustrated in FIG. 1, a server 16 can be in communication with data sources such as a user database 30A and a beverage characteristic profile database 30B, and/or the network 14. The databases 30A and 30B can be computer servers, processing systems, and/or other network elements that can send data to the devices 12A and 12B over the network 14. A beverage recommendation module 32 is in communication with the databases 30A, 30B and may be configured to carry out operations according to embodiments of the present invention and as described herein. The data in the beverage characteristic profile database 30B may be provided by a beverage characteristic data collection unit 40.

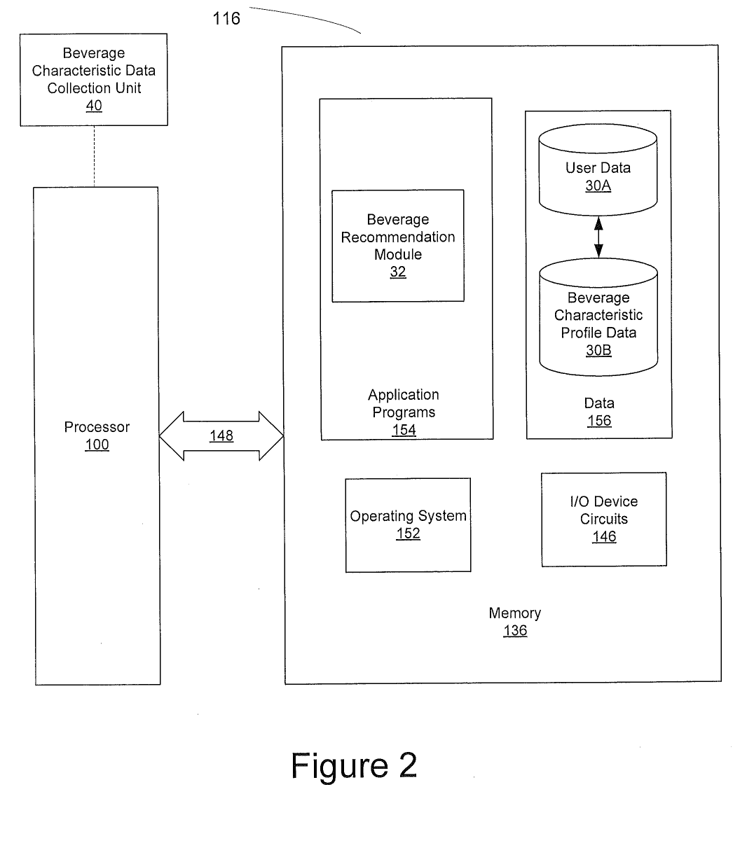

FIG. 2 illustrates an exemplary data processing system that may be included in devices operating in accordance with some embodiments of the present invention, e.g., to carry out the operations discussed herein and/or in the system described in FIG. 1. As illustrated in FIG. 2, a data processing system 116, which can be used to carry out or direct operations includes a processor 100, a memory 136 and input/output circuits 146. The data processing system 116 can be incorporated in the server and/or other components of the network, such as portable communication devices or other computer devices. The processor 100 communicates with the memory 136 via an address/data bus 148 and communicates with the input/output circuits 146. The input/output circuits 146 can be used to transfer information between the memory (memory and/or storage media) 136 and another component, such as the beverage characteristic data collection unit 40 for analyzing a sample. These components can be conventional components such as those used in many conventional data processing systems, which can be configured to operate as described herein.

The beverage characteristic data collection unit 40 may include one or more chemical analysis devices for analyzing a sample, such as nuclear magnetic resonance spectroscopy, chromatography (liquid chromatography, gas chromatography, ion chromatography), gel electrophoresis, capillary electrophoresis, mass spectroscopy, spectrophotometry, gravimetry, infra-red spectroscopy, UV-VIS spectrometry, potentiometry tubidimetry data, liquid chromatography coupled with mass spectrometry (LC/MS), gas chromatography coupled with mass spectroscopy (GC/MS), and/or mass spectroscopy coupled with mass spectroscopy (MS/MS). The beverage characteristic data collection unit 40 may also include a computer terminal and/or scanning device through which data regarding the beverage may be entered, such as price, heritage, stopper types, container/bottle attributes, labels and other characteristics of the beverage, container and/or marketing thereof.

In some embodiments, data for the beverage characteristic profile data 30B can include data that may be collected, for example, as part of quality control purposes for wine or other alcoholic beverages. See SA Kupina et al., “Evaluation of a Fourier transform infrared instrument for rapid quality-control wine analysis,” Am. Soc. Enol. Viticulture (2003); CD Patz et al., “Application of FT-MIR spectrometry in wine analysis,” Analytica Chimica Acta (2004); EP 1650545 “Multiple Sensing System, Device and Method,” and A. Legin et al., “Evaluation of Italian wine by the electronic tongue: recognition, quantitative analysis and correlation with human sensory perception,” Analytica Chimica Acta (2003).

In particular, the processor 100 can be a commercially available or custom microprocessor, microcontroller, digital signal processor or the like. The memory 136 can include any memory devices and/or storage media containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 can be a content addressable memory (CAM).

As further illustrated in FIG. 2, the memory (and/or storage media) 136 can include several categories of software and data used in the data processing system: an operating system 152; application programs 154; input/output device circuits 146; and data 156. As will be appreciated by those of skill in the art, the operating system 152 can be any operating system suitable for use with a data processing system, such as IBM®, OS/2®, AIX® or zOS® operating systems or Microsoft® Windows® operating systems Unix or Linux™. The input/output device circuits 146 typically include software routines accessed through the operating system 152 by the application program 154 to communicate with various devices. The application programs 154 are illustrative of the programs that implement the various features of the circuits and modules according to some embodiments of the present invention. Finally, the data 156 represents the static and dynamic data used by the application programs 154, the operating system 152 the input/output device circuits 146 and other software programs that can reside in the memory 136.

The data processing system 116 can include several modules, including a beverage recommendation module 32 and the like. The modules can be configured as a single module or additional modules otherwise configured to implement the operations described herein for analyzing the characteristic profile of a beverage or beverage sample and/or providing recommendations to a user. The data 156 can include the user data 30A and/or the beverage characteristic data 30B, and can be used by the beverage recommendation module 32 to recommend beverage selections and/or to receive data from the beverage collection unit 40.

While the present invention is illustrated with reference to the beverage recommendation module 32, user data 30A and the beverage characteristic data 30B in FIG. 1, as will be appreciated by those of skill in the art, other configurations fall within the scope of the present invention. For example, rather than being an application program 154, these circuits and modules can also be incorporated into the operating system 152 or other such logical division of the data processing system. Furthermore, while the beverage recommendation module 32 in FIG. 2 is illustrated in a single data processing system, as will be appreciated by those of skill in the art, such functionality can be distributed across one or more data processing systems and/or in different elements of the network of FIG. 1. Thus, the present invention should not be construed as limited to the configurations illustrated in FIG. 2, but can be provided by other arrangements and/or divisions of functions between data processing systems. For example, although FIG. 2 is illustrated as having various circuits and modules, one or more of these circuits or modules can be combined, or separated further, without departing from the scope of the present invention.

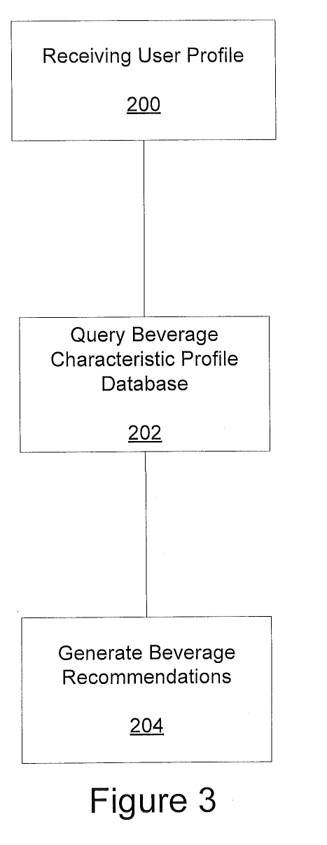

Operations that may be carried out, for example, by the beverage recommendation module 32 are illustrated in FIG. 3. An individual user profile for a user may be received (Block 200). For example, information that comprises the user profile (e.g., a well-liked beverage selection, a composite rating of several beverage ratings, demographic information, psychographic information, etc.) may be entered by a user from one of the devices 12A, 12B of FIG. 1 and stored in the user database 30A.

Information that comprises the user profile may also be obtained by other sources, such as shopping patterns, computer use and/or internet histories, and the like. User profile data may be obtained by any suitable source, including purchasing records (including online purchases), GPS data, user account information and the like. The user profile may be a simple ranking on a numeric of similar score and/or specific features of a beverage may be rated by the user. Moreover, in particular embodiments, the user profile is not associated with a user. For example, a customer may enter a single beverage selection and rating or other data and be provided with a beverage recommendation. Thus, the user profile may be registered or unregistered/anonymous and may either be stored for later use and data gathering or deleted after use. The beverage characteristic profile database 30B may be queried (Block 202) to identify the characteristic profile associated with various beverage selections. In some embodiments, the characteristic profile includes objective measurements of the beverage, such as chemical analysis. The database 30B may include various beverage selections, and each of the beverage selections may have a characteristic profile associated therewith. Beverage recommendations may be generated (Block 204) in response to the user profile and the beverage characteristic profile of the beverage selections in the beverage characteristic profile database 30B. Beverage recommendations may include receiving a user input of an identified beverage selection and determining a probable degree of user satisfaction of the identified beverage selection. The probable degree of user satisfaction is provided to the user, e.g., via a user interface such as on one of the devices 12A, 12B (FIG. 1). In some embodiments, generating one or more beverage recommendations includes identifying one or more beverage recommendations in response to the user profile and the beverage characteristic profile of the beverage selections from the beverage characteristic profile database. Accordingly, the user may request a probable degree of their satisfaction for a particular beverage, or the user may request one or more recommended beverages for their particular profile.

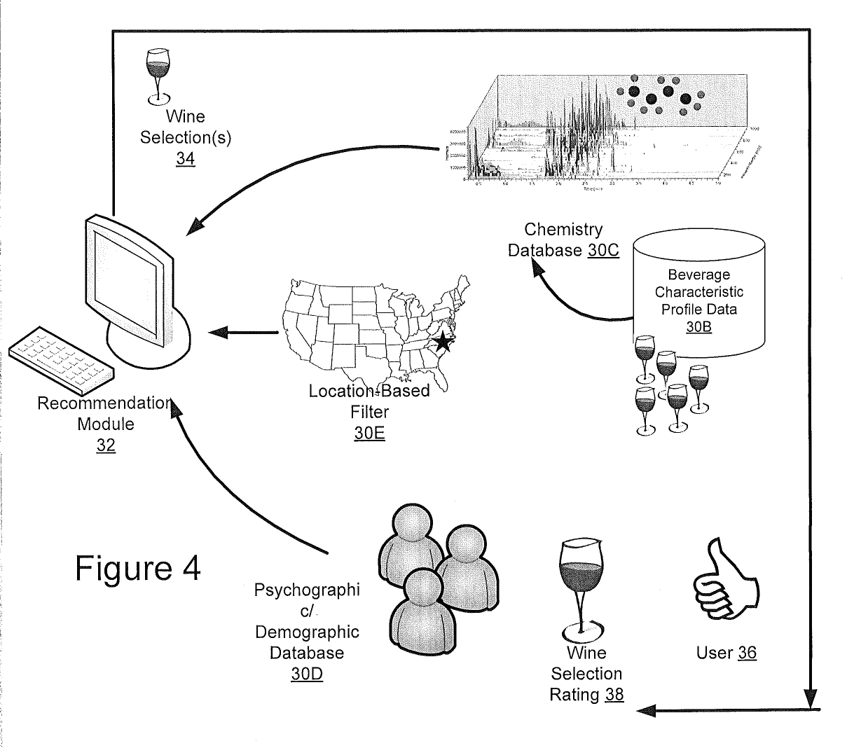

For example, as shown in FIG. 4, a user 36 enters a beverage selection rating 38, such as on one of the devices 12A, 12B of FIG. 1. The beverage selection rating 38 may be any suitable ranking, such as a numeric scale (e.g., a scale of one to three, four, five, etc.) that indicates a degree of enjoyment of the beverage. Alternatively, a user 36 could enter a single beverage or beverage identification of a well-liked beverage, such as on a bar code scanner at a store. The particular beverage that has been rated and the user beverage selection rating 38 (or a composite of ratings or other information from the user profile, including psychographic and/or demographic data) are then received by the beverage recommendation module 32. As shown in FIG. 4, the beverage recommendation module 32 may also receive data from the beverage characteristic profile database 30B (including chemistry database 30C), the psychographic/demographic database 30D, and/or the location-based filter 30E). The location-based filter 30E determines which of the beverages in the beverage characteristic profile database 30B are available to the user 38 based on the user's location. The recommendation module 32 may then make beverage selections 34 from the beverage characteristic profile database 30B, for example, in response to a comparison between the beverage sampled and rated by the user 36 and its corresponding rating and other beverages in the beverage characteristic profile database 30B such as a similarity between a highly rated beverage selection and a beverage in the beverage characteristic profile database 30B or a dissimilarity between a low rated beverage selection and a beverage the beverage characteristic profile database 30B.

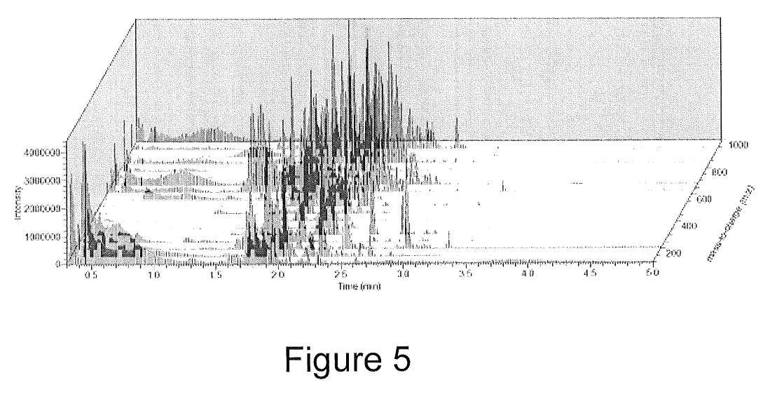

The beverage characteristic profiles of the beverage characteristic profile database may include chemical analysis data (e.g., in the chemistry database 30C), such as compound data including liquid chromatography, gas chromatography and/or mass spectroscopy data. For example, the liquid chromatography, gas chromatography and/or mass spectroscopy data may include at least one compound and a molecular weight and/or mass-to-charge ratio and a quantity associated with the compound. FIG. 5 is an exemplary graph of the ion intensity as a function of retention time and the mass-to-charge ratio for an ion trap mass spectrometry measurement of a sample. Chemical compound data, including that from nuclear magnetic resonance spectroscopy, chromatography (liquid chromatography, gas chromatography, ion chromatography), gel electrophoresis, capillary electrophoresis, mass spectroscopy, spectrophotometry, gravimetry, infra-red spectroscopy, UV-VIS spectrometry, potentiometry tubidimetry data, liquid chromatography coupled with mass spectrometry (LC/MS), gas chromatography coupled with mass spectroscopy (GC/MS), and/or mass spectroscopy coupled with mass spectroscopy (MS/MS), may be stored in the beverage characteristic profile database 30B. In some embodiments, the chemical compound data may be obtained by a liquid sample of the beverage and/or a gas sample of gas emitted from the beverage or a combination thereof. Accordingly, separate chemical analysis data may be obtained and analyzed for both the liquid portion of the beverage and the gas emitted from the beverage (or “headspace”). Thus, the liquid sample may be chemically analyzed as an indication or measurement of taste, color and/or texture, and the gas sample may be chemically analyzed as an indication or measurement of aroma and taste (which is typically influenced by aroma).

In particular embodiments, the chemical data discussed above includes characteristics of compounds in the beverage, but does not identify the at least one compound. For example, as illustrated in FIG. 5, the ion intensity as a function of retention time and mass-to-charge ratios may be used to provide a chemical profile of a sample without requiring an identification of particular compounds in the beverage. However, it should be understood that in some embodiments, various chemicals may be identified, including chemical compounds of interest, such as antioxidants, potential allergens, and other health information, and this information may be provided to a user. In some embodiments, a user may specify that he/she wishes for the beverage selections provided to have certain specified properties, such as antioxidants.

Additional chemical characteristics of the beverage may also be stored in the database 30B, such as the chemical analysis data comprises alcohol content, glucose and/or PH data for a beverage.

The following is a non-limiting example of chemical analysis that may be used to generate chemical characteristics of a beverage sample.

A syringe method may be used to collect a beverage sample, for example, for corked samples to limit exposure to oxygen and preserve the bottle.

1. A 15 to 25 mm needle was placed on a 20 mL luer lock syringe. A volume of 15 mL or more of nitrogen was then added to the syringe using a tedlar sampling bag.

2. This syringe was then pushed through the cork of the wine bottle.

3. The plunger on the syringe was pushed forward and the bottle inverted to extract the wine sample from the pressurized bottle.

4. Once extracted samples were analyzed using the mass spectrometry, chemical analyzer and pH meter as described below.

A pipet method may be used to collect a beverage sample: for samples with screw cap to limit exposure to oxygen and preserve the bottle.

1. The screw cap is removed from the sample and a glass pipet with a rubber bulb is used to quickly remove a volume of 2 mL or more the sample.

2. Nitrogen is then blown into the sample head space and the wine bottle quickly recapped.

3. Once extracted samples were analyzed using the mass spectrometry, chemical analyzer and pH meter as described below.

Additional steps may be used for beer and champagne sampling or other beverages that involve carbonated liquids in order to remove carbonation from the sample.

1. Samples were opened and 10 mL or more were placed in a 15 mL centrifuge tube.

2. Samples were then placed in a wire rack and sonicated for 20 minutes to remove carbonation.

3. Once degased samples were analyzed using the mass spectrometry, chemical analyzer and pH meter as described below.

The following is an example protocol for mass spectrometry analysis.

1. An aliquot 2 mL or more from the sample (beer, champagne or wine) was placed into auto sampler vials.

2. Vials contained very little head space and were held in the auto sampler at 4° C. in the dark until sampled.

3. A volume of 2 μL from each wine sample was separated using a C-18 column on an ultra-high performance liquid chromatography system (UHPLC). Eluent from the column was ionized using Electrospray ionization (ESI) and ionized compounds were detected using a high resolution mass analyzer (MS). Data from both positive mode and negative mode were collected.

4. Results from the mass analyzer were processed using SIEVE software from Thermo Fisher Scientific (Waltham, Mass., USA). Processed results were then used as an input to machine learning protocols for beverage recommendations.

The following is an example protocol for chemical Analyzer method for ethanol, carbonation and glucose.

1. Samples were extracted from their bottles using a syringe filled with nitrogen.

2. To determine the amount of glucose and carbonation in a sample, a volume of 100 μL or more were added to the chemical analyzer sample vials. Samples were then run according to the standard glucose chemical analyzer method and the standard carbonization method.

3. To determine the amount of ethanol in a sample, samples were first diluted 1:40 with water. They were then mixed and run according to the standard chemical analyzer method.

4. Results from the chemical analyzer were entered into a spreadsheet and used as an input to machine learning protocols for beverage recommendations.

The following is an example protocol for pH determination.

1. A volume of 10 or more mL from each wine is sampled using a syringe filed with nitrogen.

2. The pH of the sample was then determined by a pH meter.

3. The pH results were then used as an input to machine learning protocols for beverage recommendations.

In some embodiments, non-chemical characteristics of the beverages may be stored in the database 30B as part of the beverage characteristic profiles, including packaging and marketing information, such as a bottle/container shape, a stopper type (e.g., a type of wine stopper, such as cork, synthetic cork or screw top stoppers), a glass color and/or a label image. The label image may be analyzed and characterized by image recognition software or manually by observation into various classifications.

Psychographic and/or demographic data may also be collected and stored in the user database 30A (e.g., psychographic database 30D of FIG. 4) including data related to other users who showed similar likes or dislikes for similar beverages.

In some embodiments, the beverage recommendations may be based on a location of the user, and the database 30B may include information regarding where each of the beverages in the database may be purchased and/or the location-based filter 30E may be used. Therefore, the beverage selections that have a higher likelihood of being enjoyed by the user are also available at the location of the user. The location may be a general geographic location, such as a city or zip code, or the location may be a particular store, restaurant or online/Internet vendor. The location may also include online or catalog orders that are available for shipping to a particular state.

The recommended beverage selections may be identified using various techniques. For example, a user profile may include information about the user from one or more sources as described herein, including ratings for one or more beverage selections. Additional information, including demographic data, psychographic data, and the like may also be included. Thus, the user profile may be a composite of various sources of information. In particular embodiments, a user profile may include a calculation in response to the user rating(s) of a particular beverage selection or selections and a composite beverage preference may be determined.

Any suitable technique may be used to identify beverage recommendations, including machine learning software such as collaborative filtering, clustering and/or classification. Machine-learning collaborative filtering methods include user and item based collaborative filtering (CF), neighbor based CF, Bayesian belief nets CF, clustering CF, MDP based CF, latent semantic CF, sparse factor analysis, dimensionality reduction CF-SVP PCA, content-boosted CF, personality Diagnosis CF, and/or FAB content-based CF. Machine learning clustering methods include K-means, fuzzy K-means, mean shift, Dirichlet distribution, latent Direchlet allocation, and/or parallel data mining. Machine-learning classification methods include Naïve Bayes, Random Forest Decision tree, support vector machine, k-nearest neighbor, Gaussian mixture models, linear discriminant analysis, and/or logistic regression. Rule-based classifiers may also be used.

The machine learning may use the user profile and the beverage ratings as an input and provide a beverage recommendation to the user based on various machine learning patterns to predict a likelihood of a particular beverage rating. For example, the machine learning may include a machine learning cluster analyzer, a machine learning classifier and/or a machine learning collaborative filter that outputs a beverage rating probability for a user associated with the user profile to predict whether the user would like a particular beverage or to identify one or more beverages with a high likelihood of receiving a particular rating from the user. In some embodiments, the user profile may be a group profile for a group of users, for example, to aid in selecting a beverage that will be shared among the group. The group profile may be a composite profile responsive to two or more user profiles, and the beverage recommendation may be based on a probable degree of user satisfaction for two or more users associated with the two or more user profiles.

Therefore, embodiments according to the invention may be used to analyze patterns in taste preference data such as a beverage rating, psychographic data, and other user data to provide recommendations of beverages for the user to try and/or return a probability of enjoyment score for an unknown beverage having a particular chemical analysis using machine learning. For example, the user may request a probability of enjoyment score for a beverage that they would like to try to determine if they will enjoy the beverage or the user may request a recommendation of a beverage with a high probability of user enjoyment.

A beverage may be identified for a rating or to receive a recommendation/probability of enjoyment score using an image of a product, a barcode scan of the product (e.g., using a camera on a hand held device, such as a smart phone) or typing the product into a computer. Although embodiments according to the invention are described with respect to a location-based filter, it should be understood that other filters may be used and that such filters may be controlled by the user, for example, to provide a more particular beverage recommendation, such as white wine or a particular grape variety or beer classification (pale ale, Belgian ale, and the like).

Embodiments according to the present invention are described herein with respect to using machine learning patterns to predict whether a particular user will like or dislike a beverage based on the beverage characteristics, which may include a chemical analysis of the beverage. Although beer, wine and liquor beverages are provided as particular example, it should be understood that the invention may be used with other beverages, including juice, carbonated non-alcoholic beverages, coffee, non-carbonated non-alcoholic beverages.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein,

That which is claimed is:

1. A method of generating a beverage recommendation based on a probable degree of user satisfaction, the method comprising:
receiving a user profile for a user, the user profile including at least one beverage rating;
querying a beverage characteristic profile database, the database comprising a plurality of beverage selections, each of the plurality of beverage selections having a characteristic profile associated therewith; and
generating one or more beverage recommendations in response to the user profile and the beverage characteristic profile of the beverage selections from the beverage characteristic profile database.

2. The method of claim 1, wherein generating one or more beverage recommendations comprises receiving a user input of an identified beverage selection, determining a probable degree of user satisfaction of the identified beverage selection, and providing the probable degree of user satisfaction to the user.

3. The method of claim 1, wherein generating one or more beverage recommendations comprises identifying one or more beverage recommendations in response to the user profile and the beverage characteristic profile of the beverage selections from the beverage characteristic profile database.

4. The method of claim 1, wherein the beverage characteristic profiles of the beverage characteristic profile database comprise chemical analysis data.

5. The method of claim 4, wherein the chemical analysis data comprises data including data from nuclear magnetic resonance spectroscopy, chromatography (liquid chromatography, gas chromatography, ion chromatography), gel electrophoresis, capillary electrophoresis, mass spectroscopy, spectrophotometry, gravimetry, infra-red spectroscopy, UV-VIS spectrometry, potentiometry tubidimetry data, liquid chromatography coupled with mass spectrometry (LC/MS), gas chromatography coupled with mass spectroscopy (GC/MS), and/or mass spectroscopy coupled with mass spectroscopy (MS/MS).

6. The method of claim 5, wherein the chemical analysis data comprises at least one compound and a molecular weight and/or mass-to-charge ratio and a corresponding quantity.

7. The method of claim 6, wherein the chemical analysis data comprises the chemical analysis data from a liquid sample of the beverage.

8. The method of claim 6, wherein the chemical analysis data comprises the chemical analysis data from a gas sample of gas emitted from the beverage.

9. The method of claim 6, wherein the chemical analysis data comprises a characteristic of at least one compound that does not identify the at least one compound.

10. The method of claim 6, wherein the chemical analysis data comprises an identification of at least one compound.

11. The method of claim 4, wherein the beverage characteristic profiles of the beverage characteristic profile database comprise a container shape, a container type, a stopper type and/or a label image.

12. The method of claim 11, wherein generating a beverage recommendation further comprises digitally or manually analyzing the label image.

13. The method of claim 4, wherein the chemical analysis data comprises alcohol content, glucose and/or PH data.

14. The method of claim 1, further comprising determining a location of the user, wherein the step of generating one or more beverage recommendations is in response to the location of the user, and the one or more beverage recommendations include beverage selections available at the location of the user.

15. The method of claim 1, wherein the user profile is created by receiving one or more user ratings for a corresponding plurality of beverage selections for the user.

16. The method of claim 15, further comprising identifying a composite user profile in response to the user ratings and utilizing machine learning software methods selected from the group consisting of collaborative filtering, clustering and/or classification.

17. The method of claim 1, wherein the user profile further comprises psychographic data and/or demographic data.

18. The method of claim 1, wherein the beverage is wine, beer and/or liquor.

19. The method of claim 1, wherein generating a beverage recommendation in response to the user profile and the beverage characteristic profile of the beverage selections from the beverage characteristic profile database comprises applying machine learning to the user profile, wherein the machine learning is selected from the group consisting of collaborative filtering, clustering and/or classification.

20. The method in claim 19, wherein the machine learning comprises machine-learning collaborative filtering methods including user and item based collaborative filtering (CF), neighbor based CF, Bayesian belief nets CF, clustering CF, MDP based CF, latent semantic CF, sparse factor analysis, dimensionality reduction CF-SVP PCA, content-boosted CF, personality Diagnosis CF, and/or FAB content-based CF.

21. The method in claim 19, wherein the machine learning comprises machine-learning clustering methods including K-means, fuzzy K-means, mean shift, Dirichlet distribution, latent Direchlet allocation, and/or parallel data mining.

22. The method in claim 19, wherein the machine learning comprises machine-learning classification methods including Naïve Bayes, Random Forest Decision tree, support vector machine, k-nearest neighbor, Gaussian mixture models, linear discriminant analysis, and/or logistic regression.

23. The method of claim 19, wherein the machine learning comprises a machine learning cluster analyzer, a machine learning classifier and/or a machine learning collaborative filter that outputs a beverage rating probability for a user associated with the user profile.

24. The method of claim 23, wherein the beverage rating probability comprises a probable rating for a particular beverage selection and/or a beverage recommendation.

25. The method of claim 1, wherein the user profile comprises a group profile including a composite profile responsive to two or more user profiles, and wherein the beverage recommendation is based on a probable degree of user satisfaction for two or more users associated with the two or more user profiles.

26. A system for generating a beverage recommendation, the system comprising:
a user interface device configured to receive data for a user profile for a user; and
a beverage recommendation module in communication with the user interface device configured to query a beverage characteristic profile database, the database comprising a plurality of beverage selections, each of the plurality of beverage selections having a characteristic profile associated therewith; and to generate one or more beverage recommendations in response to the user profile and the beverage characteristic profile of the beverage selections from the beverage characteristic profile database.

27. A computer program product for generating a beverage recommendation, the computer program product comprising a computer readable medium having computer readable program code embodied therein, the computer readable program code comprising:
computer readable program code configured to receive a user profile for a user;
computer readable program code configured to query a beverage characteristic profile database, the database comprising a plurality of beverage selections, each of the plurality of beverage selections having a characteristic profile associated therewith; and
computer readable program code configured to generate one or more beverage recommendations in response to the user profile and the beverage characteristic profile of the beverage selections from the beverage characteristic profile database.

28. A user interface apparatus for generating a beverage recommendation, the apparatus comprising:
a user interface module configured to receive a user profile for a user; and
a processor configured to communicate the user profile to a beverage recommendation module, the beverage recommendation module configured to query a beverage characteristic profile database, wherein the database comprises a plurality of beverage selections, each of the plurality of beverage selections having a characteristic profile associated therewith, wherein the beverage recommendation module is further configured to generate one or more beverage recommendations in response to the user profile and the beverage characteristic profile of the beverage selections from the beverage characteristic profile database and to communicate the one or more beverage selections to the processor.
